(19) United States
(12) Patent Application Publication
(10) Pub. No.: US 2022/0263149 A1
(43) Pub. Date: Aug. 18, 2022

(54) Battery Temperature Control System

(71) Applicant: Heatworks Technologies, Inc., Sullivan's Island, SC (US)

(72) Inventor: Jeremiah M. Callahan, Sullivan's Island, SC (US)

(73) Assignee: Heatworks Technologies, Inc., Sullivan's Island, SC (US)

(21) Appl. No.: 17/623,071

(22) PCT Filed: Jun. 25, 2020
(86) PCT No.: PCT/US2020/039559

§ 371 Date: Dec. 27, 2021

Related U.S. Application Data
(60) Provisional application No. 62/868,236, filed on Jun. 28, 2019.

(51) Int. Cl. H01M 10/63; H01M 10/615; H01M 10/6571; H01M 10/48; H01M 10/625; B60L 58/27; H05B 3/60

(52) U.S. Cl. CPC H01M 10/63; H01M 10/615; H01M 10/6571; H01M 10/486; B60L 2240/545; B60L 58/27; H05B 3/60; H01M 2220/20; H01M 10/625

(57) ABSTRACT

A temperature control system for an electrical storage battery (12) includes the battery and a vessel (20) adapted to contain a liquid (L). The vessel is in thermal communication with the battery. An ohmic heater includes electrodes (42) disposed within the vessel in contact with the liquid (L), and a controller (44) operative to apply different electrical potentials to different ones of the electrodes (42) so that an electrical current flows between the electrodes so as to heat the liquid and thus heat the battery. A temperature sensor (46) measures temperature of the battery, and the controller is responsive to the measured temperature of the battery to control the electric current and thereby control the heating.

### CROSS-REFERENCE TO RELATED APPLICATIONS

The present application claims the benefit of U.S. Provisional Patent Application 62/868,236, filed Jun. 28, 2019, the disclosure of which is incorporated herein by reference.

### BACKGROUND OF THE INVENTION

Electric vehicles such as passenger cars commonly employ storage batteries as, for example, lithium-ion batteries as an energy source. In a “pure” electric vehicle, the batteries are charged only by an external source such as a connection to a charger powered by an electric utility while the vehicle is at rest, with supplemental charging by power generated in regenerative braking during driving. In a “hybrid” electric vehicle, the battery is charged by operation of a combustion engine driving a generator during operation, with or without supplemental charging by an external charger while the vehicle is at rest. Large storage batteries are also used in fixed power systems such as utility power systems and power systems in buildings to provide power during intervals when a power generating source is inoperative, or when power demand exceeds the capacity of the source. For example, the batteries may be charged by a source such as a solar or wind generator which provides power intermittently, so that the batteries can provide power when the source is inoperative. The batteries typically cannot be charged properly while they are at very low temperatures as, for example, at ambient temperatures prevalent in northern climates during the winter. Moreover, at such temperatures the batteries typically do not provide nearly as much power as at higher temperatures. For these reasons, batteries commonly are equipped with a temperature control system. One common system which has been proposed uses containing a heat exchange medium as, for example, a water and ethylene glycol mixture. Parts of the vessel are in thermal communication with the battery. For example, the vessel may include a reservoir and one or more pipes or tubes extending within an enclosure housing the battery. The temperature control system typically includes an electrical resistance heater having a solid resistance element mounted in or near a portion of the vessel. A pump may be provided for impelling the liquid within the vessel as, for example, to circulate the liquid from the reservoir through the heater and through the pipes disposed in the battery container. A control system incorporating a temperature sensor in thermal communication with the battery is also provided. When the battery is at a temperature below a set temperature, the control system draws power, either from an external source or from the battery itself, and supplies that power to the heater and the pump so as to heat the liquid and thus heat the battery.

One aspect of the present invention provides a temperature control system for a battery such as a battery in an electric vehicle or a fixed power system. A system according to this aspect of this invention includes a battery, a vessel in thermal communication with the battery, the vessel being adapted to hold a liquid. An ohmic heater, including a plurality of electrodes, is also provided. The electrodes are disposed within the vessel so as to contact liquid within the vessel. The heater desirably also includes a controller adapted to apply different electrical potentials to different ones of the electrodes so that an electrical current passes through the liquid. The system desirably also includes a thermal sensor in thermal communication with the battery for providing a signal representing temperature of the battery. The controller desirably is responsive to the signal to control the current passing through the liquid. The controller may draw the energy applied to the electrodes from the battery itself or from an external source, such as an external battery.

### BRIEF DESCRIPTION OF THE DRAWINGS

FIG. 1 is a diagrammatic, partially sectional view of a system according to one embodiment of the invention.

### DESCRIPTION

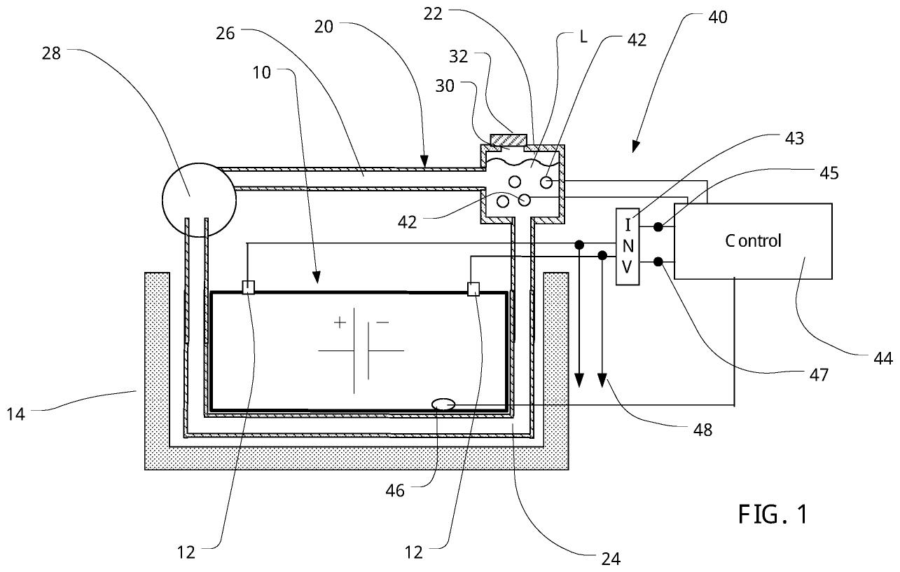

A system according to one embodiment of the invention is schematically shown in FIG. 1. The system includes a battery 10 having terminals 12. Battery 10 typically is disposed within an enclosure 14. The system further includes a vessel 20 adapted to contain a liquid. In this embodiment, the vessel 20 includes a reservoir 20 and conduits 24 and 26 communicating with the reservoir. A part of the vessel, in this case conduit 24, is disposed in thermal communication with battery 10. In this embodiment, conduit 24 extending inside housing 14 in proximity to the battery 10. In the schematic diagram of FIG. 1, battery 10 is illustrated as a monolithic structure. However, in practice the battery typically includes numerous cells or smaller batteries electrically connected to one another and the conduit or conduits extends in proximity to all of the cells or smaller batteries. For example, the conduits may extend through spaces between the cells or smaller batteries. The system according to this embodiment further includes a pump 28 for circulating the liquid contained in reservoir 20 through conduits 24 and 26. The pump incorporates an electric drive motor (not shown). Vessel 20 may be provided with a fill opening 30 having a removable cap as, for example, at the top of reservoir 22 as shown. A drain opening (not shown) may be provided at a low point in the vessel as, for example, in conduit 24.

The system further includes an ohmic heater 40. Heater 40 includes electrodes 42. Although only a few electrodes are depicted in FIG. 1, the ohmic heater may include any number of electrodes. The electrodes 42 are disposed within vessel 20 so that the electrodes will be in contact with a liquid L contained within the vessel. Although the electrodes are depicted as disposed within reservoir 20, this is not essential. For example, the electrodes can be disposed within one of the conduits. The heater further includes a controller 42. The controller is connected to all of the electrodes 42; only a few of these connections are depicted in FIG. 1 for clarity of illustration. The controller is also connected to the terminals or poles 45 and 47 of an inverter 43. Inverter 45 is connected to terminals 12 of battery 10. The inverter is arranged to convert the DC potential applied by battery 10 to an alternating potential. For example, the inverter may be arranged to maintain pole 47 at a fixed potential such as a ground potential, and to provide an alternating potential at pole 45. Thus, the controller can draw power from the battery through the inverter. Alternatively, the controller can be connected to another power supply as, for example, a supplemental battery and inverter (not shown) or terminals (not shown) which can be connected to an external source of power such as an AC utility power supply. A temperature sensor 46 is provided in thermal communication with the battery. Here again, the temperature sensor is depicted as a single element, but may include multiple elements in thermal communication with multiple portions of the battery. The temperature sensor 46 is arranged to provide one or more signals to the controller 44 indicating the temperature of battery 10. Controller 44 is arranged to connect different ones of the electrodes 42 to different poles of the power supply having different electrical potentials. Typically, the controller incorporates at least one switch for each electrode. The switches typically are semiconductor switches operable to change between a low resistance “on” state and a very high resistance “off” state. The switches are arranged to selectively connect the electrodes to poles of the power supply and disconnect the electrodes from the power supply, so that different sets of electrodes can be connected and disconnected.

When the electrodes are connected, an electrical current will flow through the liquid L between the electrodes connected to different poles of the power supply, and thus heat the liquid. As explained in U.S. Pat. Nos. 7,817,906 and 9,587,853 and in Patent Cooperation Treaty International Application PCT/US2019/031752, the disclosures of which are incorporated by reference herein, and copies of which are annexed hereto, the current flow through the liquid depends strongly on the geometry of the electrodes as, for example, on the spacing between electrodes connected to different polarities. As also explained in the foregoing applications, the electrodes may be arranged so that different connection schemes will provide different resistances between the poles of the power supply, i.e., between the poles 45 and 47 of the inverter, and thus provide a different power dissipation and different heating rates. With a given connection scheme, the electrical resistance between the poles of the power supply decreases as the conductivity of the liquid increases, so that the current flow through the liquid and the rate at which electrical energy is converted to heat within the liquid increases. A parameter referred to herein as “specific resistance” is used in this disclosure to characterize a circuit or a part of a circuit having elements electrically connected to one another by a liquid. The specific resistance as used herein is the ratio between the electrical resistance of the circuit or part of the circuit and the resistivity of the liquid in the circuit. As discussed in the foregoing publications, certain electrode configurations can provide a wide range of specific resistances with a large number of different specific resistances between the ends of the range so as to provide a large number of heating rates with small steps therebetween for a liquid of any conductivity within a wide range of conductivities.

References to position or orientation of components as used herein refer to the position of the components when the system is mounted in its normal operating position. For example, where the system is mounted in a wheeled vehicle, the system is in its normal operating position when the vehicle is in its normal upright position with the wheels of the vehicle resting on a level surface. Battery 10 is connected other components of the power system as schematically indicated by connection 48, so that these other components can draw power from the battery to perform useful work or charge the battery. For example, in a pure electric vehicle, connection 48 may connect the battery to components such as traction motors which drive the vehicle along the road and which act as generators to charge the battery during braking, and to a charging port for charging the battery from an external source of power. Controller 44 may be connected to a larger control system (not shown) which controls operation of the power system as a whole or may be a part of the larger control system. For example, when the battery is mounted in an electric vehicle, controller 44 may be connected to the vehicle's control system. When controller 44 receives an input, such as a signal from the larger control system or a manual input indicating that the battery should be prepared for charging or for discharging and when the signal from sensor 46 indicates that the temperature of the battery is below a desired operating temperature, controller 44 actuates pump 28 to circulate the liquid L within vessel 20 and connects two or more of the electrodes to the terminals or poles 12 of battery 10 so as to provide a current within the liquid and thus heat the liquid at a desired heating rate. Controller 44 may alter the connection scheme to reduce the heating rate, or terminate the heating entirely as the temperature of the battery increases.

Use of an ohmic heater as described hereinabove provides a significant advantage in safety. If a leak in the vessel causes the level of liquid in the vessel to drop below the electrodes, the electrical resistances between the electrodes will rise by many orders of magnitude so that the power or heating rate becomes zero or nearly zero. This is true even if the pump continues to circulate some of the liquid. Thus, if a leak occurs in vessel 20 so that some of the liquid is lost, the ohmic heater will not cause the temperature of any component in the system to rise to a dangerous destructive level, even if the control system 44 or sensor 46 malfunctions so as to cause an unintended application of electrical potential to the electrodes. Likewise, if the liquid is present but the liquid temperature rises to the boiling point of the liquid, the heating rate will decline dramatically as gas bubbles form within the liquid.

Moreover, the ohmic heater can be inexpensive and compact. As discussed in the publications mentioned above, ohmic heaters heretofore have incorporated numerous electrodes so as to provide satisfactory operation with liquids of widely varying conductivities as, for example, where and ohmic heater is employed to heat potable water. However, the liquid L in the system desirably is a permanent or semi-permanent part of the system. Typically, the liquid is installed at the factory and is replaced or replenished with a liquid specifically selected for use in the system. In this case, it is not necessary to accommodate a wide range of conductivities and the heater may have only a few electrodes. Thus, the controller may incorporate a relatively small number of switches. Stated another way, in the particular environment of a battery heating system, the ohmic heater may be a very simple and inexpensive device. Indeed, where the conductivity of the liquid is particularly well-controlled, the ohmic heater may include only two electrodes, and only a single switch operable to make or break a circuit between a pole of the inverter and one of the electrodes, the other electrode being permanently connected to the other terminal of the inverter.

Numerous variations and combinations of the features set forth above may be used. For example, the temperature control system may incorporate elements for cooling the liquid to maintain the temperature of the battery at or below a present upper limit. Such cooling elements may include, for example, a radiator with a thermostatic control or other conventional elements. The electrodes of the ohmic heater need not be disposed in a reservoir. For example, the electrodes may be disposed within one or more of the pipes or conduits which form part of the vessel. Also, although the vessel 20 and parts thereof such as conduit 24 are depicted as structurally separate from the other elements of the system, this is not essential. For example, the casing of the battery 10, the enclosure 14, or both may form parts or all of the walls of the vessel 20.

In still other variants, the function of the inverter can be performed by the switches incorporated in the controller. For example, the switches may be arranged to connect a pair of electrodes to the terminals 12 of the battery so that one electrode of the pair is connected to the positive terminal while the other electrode is connected to the negative terminal, and to repeatedly reverse these connections so that an alternating potential is applied between each pair of connected electrodes. The alternating potential is desirable to avoid polarization of the electrodes and electrolysis of the liquid. However, in other embodiments a direct potential with fixed polarity can be used. For example, the controller may connect electrodes of each connected pair to the positive and negative terminals of the battery, either continually or intermittently, without reversing the connections.

The foregoing description should be taken as illustrating rather than as limiting the invention as set forth in the claims.

1. A temperature control system comprising:
(a) a battery;
(b) a vessel, the vessel being adapted to hold a liquid, at least part of the vessel being in thermal communication with the battery;
(c) an ohmic heater including a plurality of electrodes disposed within the vessel so as to contact liquid within the vessel and a controller adapted to apply different electrical potentials to different ones of the electrodes so that an electrical current passes through the liquid; and
(d) a thermal sensor in thermal communication with the battery for providing a signal representing temperature of the battery, the controller being responsive to the signal to control the electrical current.

2. A system as claimed in claim 1 wherein the vessel includes one or more conduits.

3. A system as claimed in claim 2 further comprising a pump in communication with the conduits for circulating liquid within the vessel.

4. A system as claimed in claim 1 further comprising an inverter, the inverter having a plurality of poles and being operable to apply an alternating potential between the poles, wherein the controller is operable to connect different ones of the electrodes to different poles of the inverter.

5. A system as claimed in claim 4 wherein the inverter is connected to the battery and is operable to draw power from the battery.

6. A system as claimed in claim 1 wherein the controller is operative to connect pairs of electrodes to opposite poles of the battery.

7. A system as claimed in claim 6 wherein the controller is operative to repeatedly reverse the connections between the pairs of electrodes and the poles of the battery, so that an alternating potential is applied between each pair of connected electrodes.

8. An electric vehicle having a vehicle body and a system as claimed in claim 1 mounted within the vehicle body.
